(19) United States
(12) Patent Application Publication
(10) Pub. No.: US 2025/0242391 A1
(43) Pub. Date: Jul. 31, 2025

(54) APPARATUS FOR CLEANING SURFACES AND LINES ON A GAME PLAYING SURFACE

(71) Applicant: The Marketing Baron, LLC, Palmetto, FL (US)

(72) Inventor: BLAKE S. BARON, Palmetto, FL (US)

(21) Appl. No.: 19/019,580

(22) Filed: Jan. 14, 2025

Related U.S. Application Data
(60) Provisional application No. 63/627,096, filed on Jan. 31, 2024.

(51) Int. Cl. B08B 5/02

(52) U.S. Cl. CPC B08B 5/02

(57) ABSTRACT

An apparatus for cleaning surfaces and lines on a game playing surface includes a housing having first and second ends. An air passage extends from the first end to the second end. The first end is configured to connect to a portable, handheld air blower. At least one ground engaging wheel is carried by the housing and allows the housing to be rolled over the game playing surface. An air discharge is formed at the second end of the housing and configured to blow air over the width of a line on the game playing surface as the housing is rolled over the line of the game playing surface when the housing is connected to and receives air discharged from an air blower connected thereto.

### PRIORITY APPLICATION(S)

This patent application is based upon U.S. provisional patent Application No. 63/627,096 filed Jan. 31, 2024, the disclosure which is hereby incorporated by reference in its entirety.

### FIELD OF THE INVENTION

The present invention relates to cleaning game playing surfaces and more particularly, to cleaning surfaces and lines on a game playing surface, such as a clay tennis court.

### BACKGROUND OF THE INVENTION

A game playing surface, such as a tennis court, and more particularly, a clay tennis court, requires optimal playing conditions that require regular maintenance. This includes brushing or raking the surface to smooth the surface and remove marks and debris. This process is usually followed by a crucial step of creating clear white lines by brushing the lines and removing debris on the lines. Clay tennis courts include green, red or brown Har-Tru surfaces where most modern brushes typically clear about 60% to about 70% of the clay off the tennis lines, making the task strenuous and time-consuming. Many maintenance workers and players find the current tools inadequate, and thus, often neglect the tennis lines saying that they are adequate for continued play. However, these inadequately cleaned lines can affect the bounce of the ball during game play.

Conventional line cleaning systems may include heavy-duty brushes that incorporate somewhat durable nylon brush heads that are used primarily for removing the built-up debris from the clay that accumulates on the tennis lines and on the nails that hold the tennis lines to the court. This is at the minimum a weekly chore. Some line cleaning systems use roller brushes that may be adjusted with an ability to raise and lower the brush to adjust the cleaning depth. In many of these systems, angle position has to be almost perfect to attain any level of sweeping the lines free of clay, making these devices inadequate.

There have also been brushes supported on all-terrain tires with knobby tires that provide traction on soft clay tennis courts. These systems are designed for traction and often leave marks (divots) on each side of the line, and players may have about 6 inches of questionable tennis ball bounces on the sidelines and baselines created by a 2 inch line plus a 2 inch questionable area on each side of the line having the tread mark.

Example tennis line cleaners for clay tennis courts that have been found inadequate include the Match Liner, the Line Master, and the Linien Blitz. These units include a roller assembly and some type of brush system that unfortunately often inadequately cleans the tennis lines. Therefore, an apparatus that adequately cleans lines on a game playing surface, such as a clay tennis court is desired, and may also be used to clean other surface areas, such as on a clay tennis court or other game playing surface.

### SUMMARY OF THE INVENTION

An apparatus for cleaning surfaces and lines on a game playing surface may comprise a housing having first and second ends. An air passage may extend from the first end to the second end. The first end may be configured to connect to a portable, handheld air blower. At least one ground engaging wheel may be carried by the housing. The ground engaging wheel may be configured to allow the housing to be rolled over the game playing surface. An air discharge may be formed at the second end of the housing. The air discharge may be configured to blow air over the width of a line on the game playing surface as the housing is rolled over the line of the game playing surface when the housing is connected to and receives air discharged from an air blower connected thereto.

The air discharge may be configured as a rectangular protrusion extending outward from a lower section of the housing. The protrusion may have a width about equal to the width of lines on the game playing surface. The second end of the housing may form a tubular opening. A nose cap may be secured onto the second end at the tubular opening to prevent air from passing out of the tubular opening. The tubular opening may be configured to receive a nozzle attachment when the nose cap is removed from the second end of the housing. The second end of the housing may include a locking post. The nose cap and nozzle attachment may each include an L-shaped slot configured to pass over the locking post to lock the respective nose cap or nozzle attachment onto the second end of the housing.

Opposing ground engaging wheels may be carried by the second end of the housing. A single ground engaging wheel may be carried by the second end of the housing.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a perspective, environmental view of the apparatus for cleaning surfaces and lines on a game playing surface, such as the illustrated clay tennis court, in use by an operator and connected to a portable, handheld air blower.

FIG. 2 is another perspective view of the apparatus of FIG. 1 showing the portable, handheld air blower disengaged from the apparatus.

FIG. 3 are images of two different configurations of the elbow section that connects to the tapered section of the housing.

FIG. 4 is another perspective view of the apparatus of FIG. 1.

FIG. 5 is a side elevation view of the apparatus of FIG. 1.

FIG. 6 is a front perspective view of the apparatus of FIG. 1.

FIG. 7 is a side perspective view of a portion of the apparatus showing the nose cap removed from the tubular opening at the second end of the housing.

FIG. 8 is another perspective view of the apparatus showing a nozzle attachment that may be attached to the second end of the housing when the nose cap is removed.

FIG. 9 is a rear perspective view of a portion of the apparatus shown without ground engaging wheels and showing another configuration of the nozzle attachment.

FIG. 10 is a front perspective view of the apparatus showing the nozzle attachment similar to that shown in FIG. 9 connected to the second end of the housing.

FIG. 11 is a side elevation view of the apparatus shown in FIG. 10.

FIG. 12 is a side elevation view of the apparatus where the second end of the housing includes an extended nose cap and the air discharge formed therein.

FIG. 13 is a perspective view of the apparatus looking from the bottom and showing an extended nose cap that supports opposing dual wheels and the air discharge formed within the lower elbow section.

FIG. 14 is another view of the apparatus similar to FIG. 14 showing a single ground engaging wheel carried by the extended nose cap instead of opposing, dual wheels.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

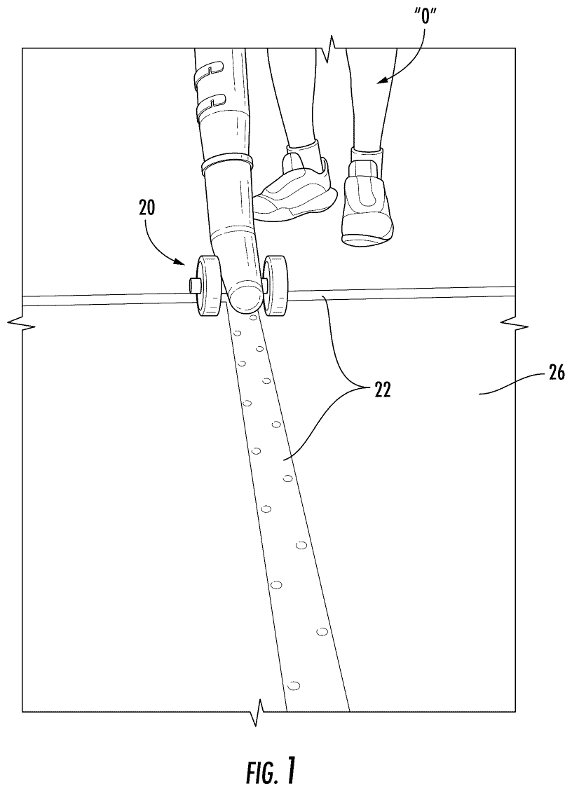

Referring now to FIG. 1, there is illustrated an environmental perspective view of the apparatus 20 in use by an operator (O), shown cleaning a tennis court line 22 on the game playing surface 26, which in this example is a clay tennis court. The operator (O) is pushing the apparatus 20 along the tennis court line 22 to blow the clay and other debris from the line so that clean lines exist, which will not impact the tennis ball bounce during game play.

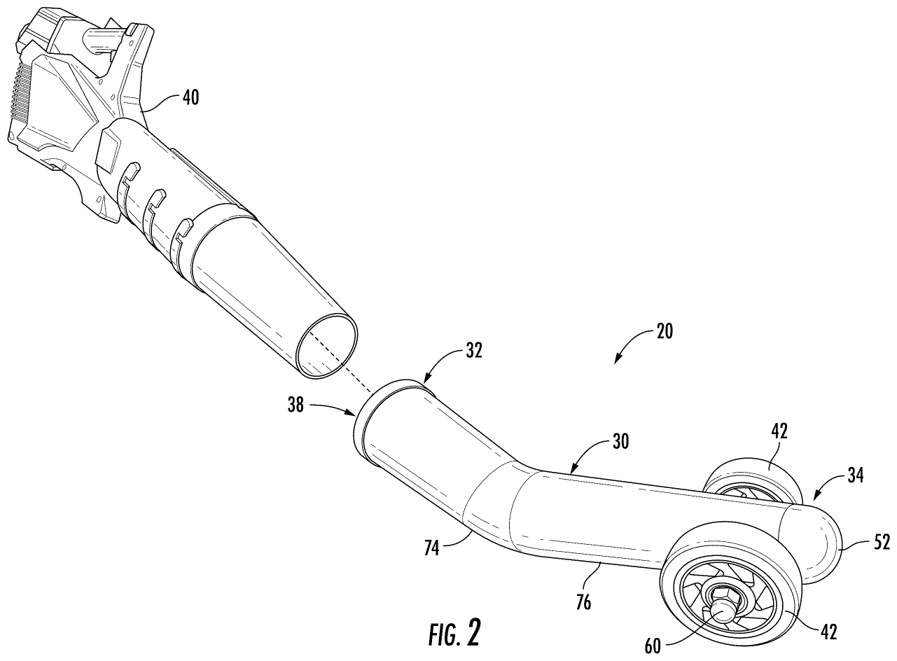

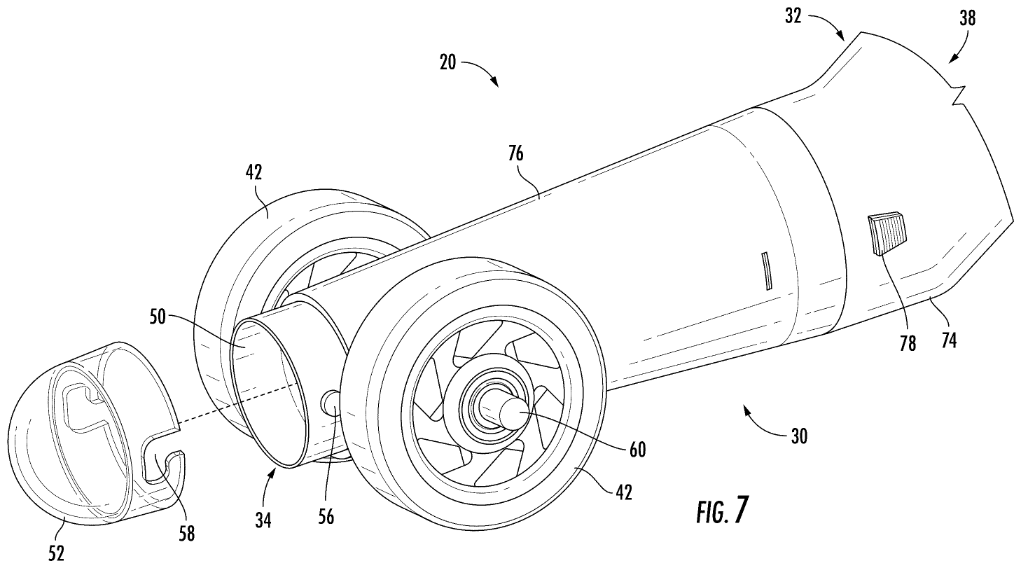

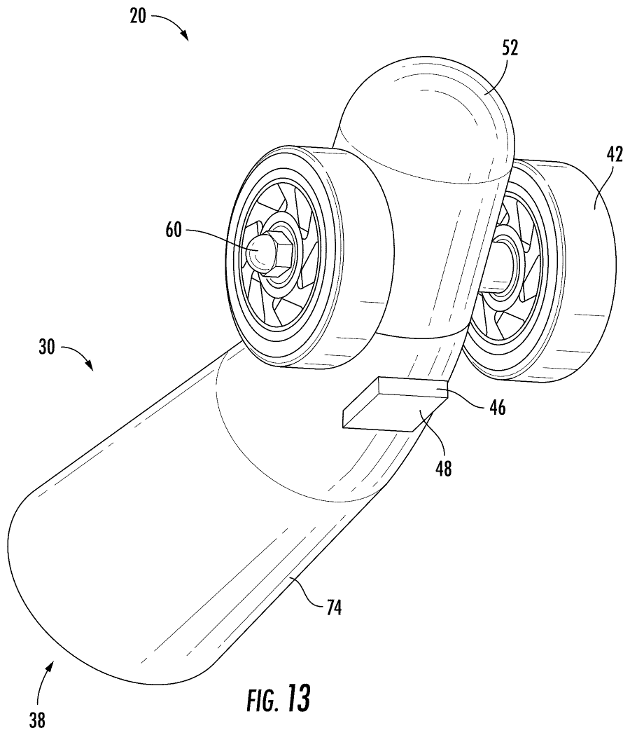

As shown also in FIG. 2 and FIGS. 4-7, the apparatus 20 includes a housing 30 having first and second ends 32,34 and an air passage 38 extending from the first end to the second end. In this example, the housing 30 is tubular in structure. The first end 32 of the housing 30 is configured to connect to a portable, handheld air blower 40 as shown in FIG. 2 and receive air discharged from the air blower into the air passage. At least one ground engaging wheel 42 and as illustrated, two opposing ground engaging wheels, are carried by the housing 30 near the second end 34 and configured to allow the housing to be rolled over the game playing surface 26, e.g., the clay tennis court (FIG. 1). In the example of FIG. 13 as explained below, only a single ground engaging wheel 42 is carried by the housing 30.

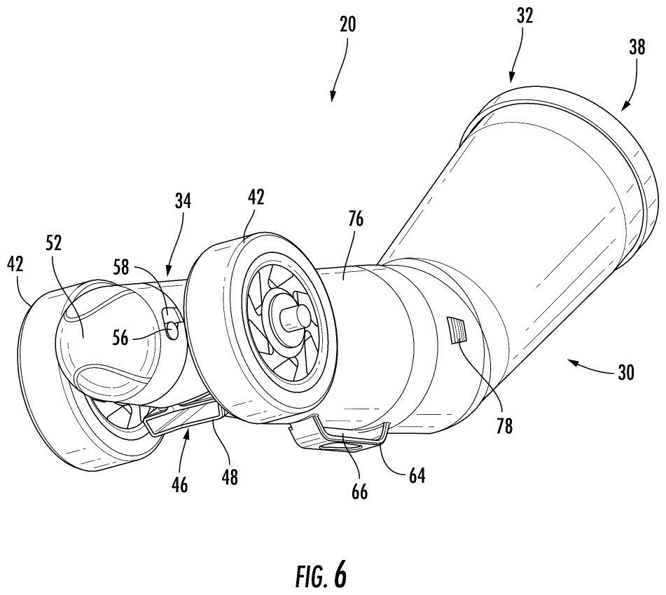

An air discharge 46 is formed at the second end of the housing 30, and configured to blow air over the width of a line 22 on the game playing surface 26 as the housing is rolled over the line of the game playing surface when the housing is connected to and receives air discharged from the air blower 40. At best shown in FIG. 6, the air discharge 46 is configured as a rectangular protrusion 48 extending outward from a lower section of the housing 30 and has a width equal to the width of lines 22 on the game playing surface 26. In this example, the lines 22 of the game playing surface 26 may be tennis court lines, which are about two (2) inches wide. The rectangular protrusion 48 may be about ¼ inch to about ½ inch in height, and about two (2) inches wide corresponding to the tennis court line 22. The second end 34 of the housing 30 forms a tubular opening 50, and a nose cap 52 is secured onto the second end 34 and covers the tubular opening to prevent air from passing out of the tubular opening. The nose cap 52 is a diameter about the size of a tennis ball when cut in half.

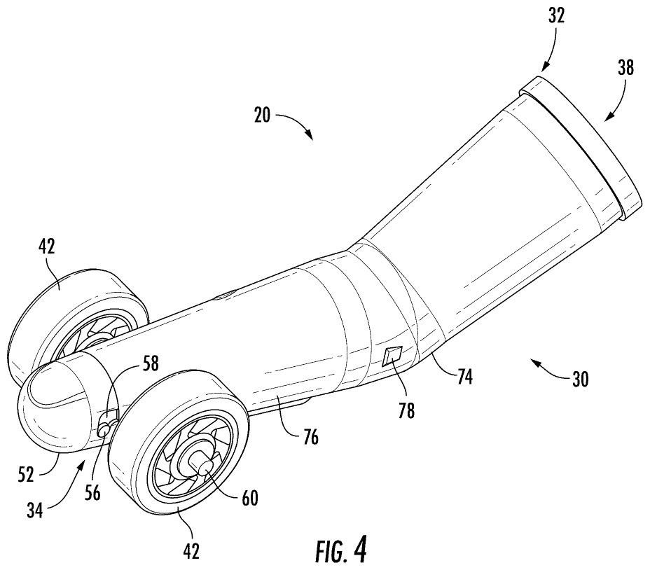

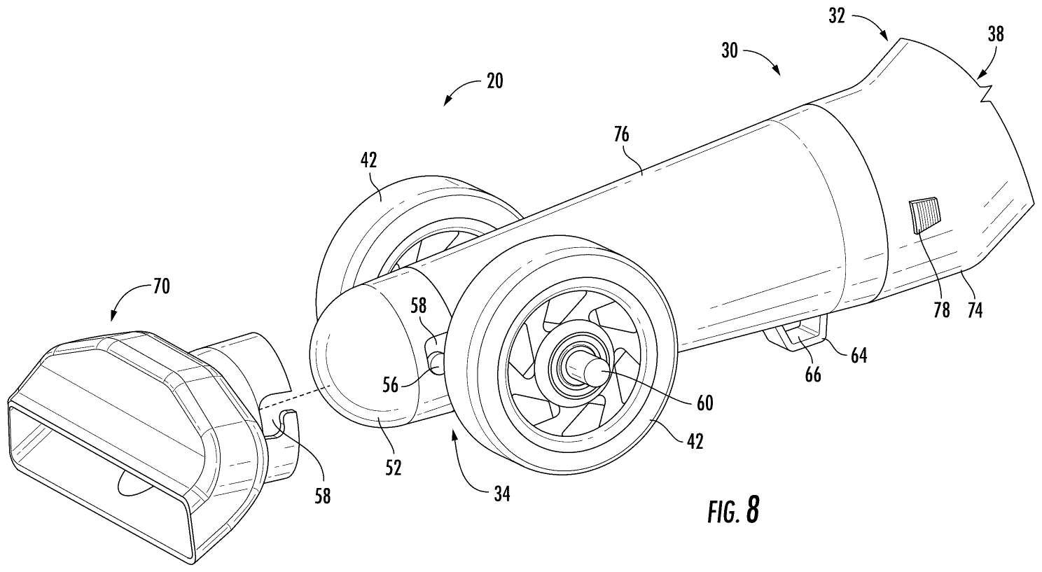

The second end 34 of the housing 30 includes a locking post 56 as best shown in FIGS. 4 and 6-9. The nose cap 52 includes an L-shaped slot 58 configured to pass over the locking post to lock the nose cap onto the second end 34 of the housing 30 and cover the tubular opening 50. In operation, the nose cap 52 is placed onto the second end 34 of the housing 30 so that the locking post 56 is received initially into the L-shaped slot 58. The nose cap 52 is turned slightly so that the L-shaped slot 58 locks relative to the locking post 56 as shown in FIGS. 4 and 8, where the nose cap is locked onto the second end 34 of the housing 30.

As shown in FIGS. 4-8, the ground engaging wheels 42 are connected to a central shaft 60 that may be split as two different support shafts for either side of the housing 30. The ground engaging wheels 42 may be formed from polyurethane, high-density polyethylene, other polyethylenes, polyvinyl chlorides, or other lightweight plastic or metallic materials to provide a lightweight wheel assembly. In an example, the central shaft 60 is a 7 inch stainless steel shaft with an M12 metric diameter. It could be locked with each of the ground engaging wheels 42 using a hexagonal lock nut and a cap nut as non-limiting examples. The ground engaging wheels 42 may have a diameter of about 4 inches so that when the apparatus 20 is rolled along the game playing surface 26 such as the clay tennis court, the air discharge 46 formed in this example as a rectangular protrusion 48 (FIG. 6) is positioned adjacent and slightly above the tennis court line 22 or other lines being cleaned.

As shown in FIGS. 4-6 and 8, a ground engaging member 64 is positioned on the housing 30 and configured to engage the ground, such as the game playing surface 26, and prevent the housing 30 from resting on the ground when the apparatus 20 is not in use. This ground engaging member 64 is formed as a rectangular, U-shaped member that includes a central hole 66 allowing the apparatus to be stored, such as by passing a hook or other mounting member through the open hole defined by the rectangular configured ground engaging member.

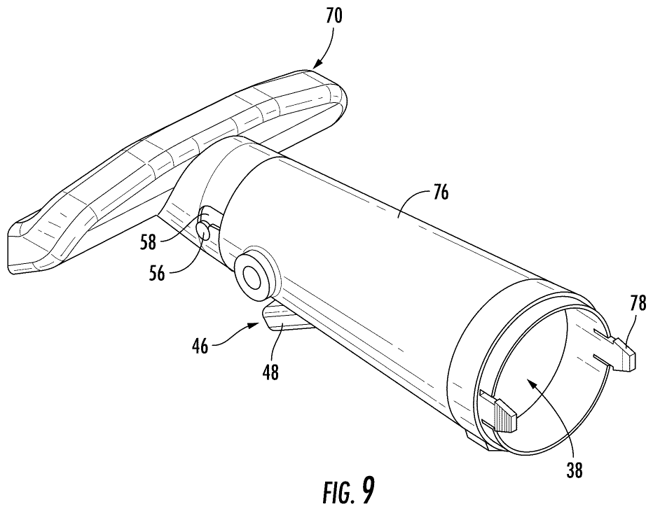

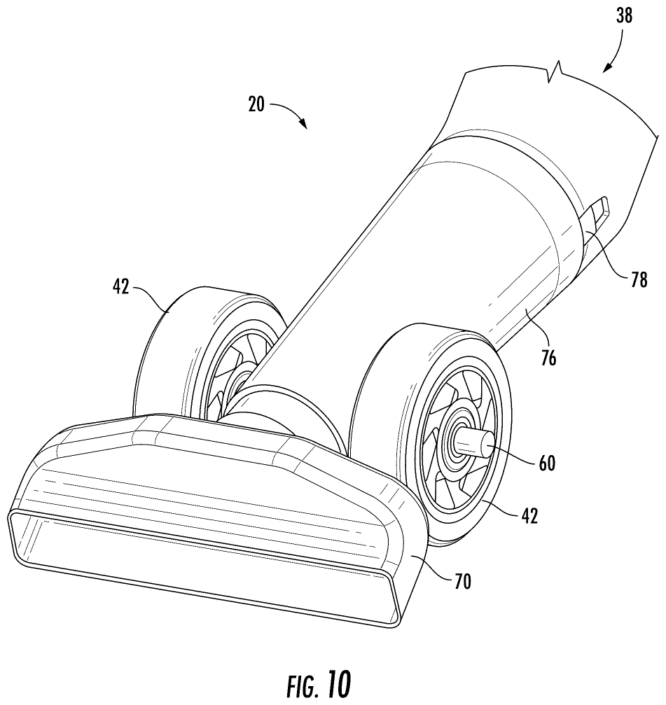

A nozzle attachment 70 (FIGS. 8-11) is configured to attach to the second end 34 of the housing 30 when the nose cap 52 is removed from the second end of the housing. When the nozzle attachment 70 is connected, air may be discharged through the nozzle attachment and the air discharge 46, depending on configuration. This nozzle attachment 70 as shown in FIGS. 9 and 10 has a wider air discharge that is rectangular configured and extends the width beyond each wheel by about ½ inch to 1 inch to allow the apparatus 20 to be used to clean larger sections of the game playing surface 26 besides the lines 22, such as the edges, and remove clay or other debris that may accumulate at the edges of the game playing surface. The nozzle attachment 70 is also termed a “dozer” attachment because it is shaped similar to a bulldozer blade. The nozzle attachment 70 also includes an L-shaped slot 58 similar to that formed in the nose cap 52, and configured to pass over the locking post 56 and lock the nozzle attachment onto the second end 34 of the housing 30.

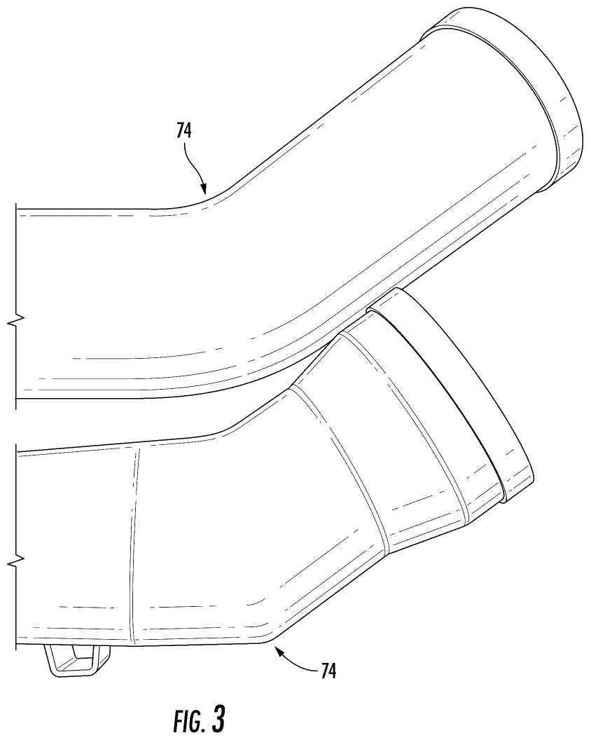

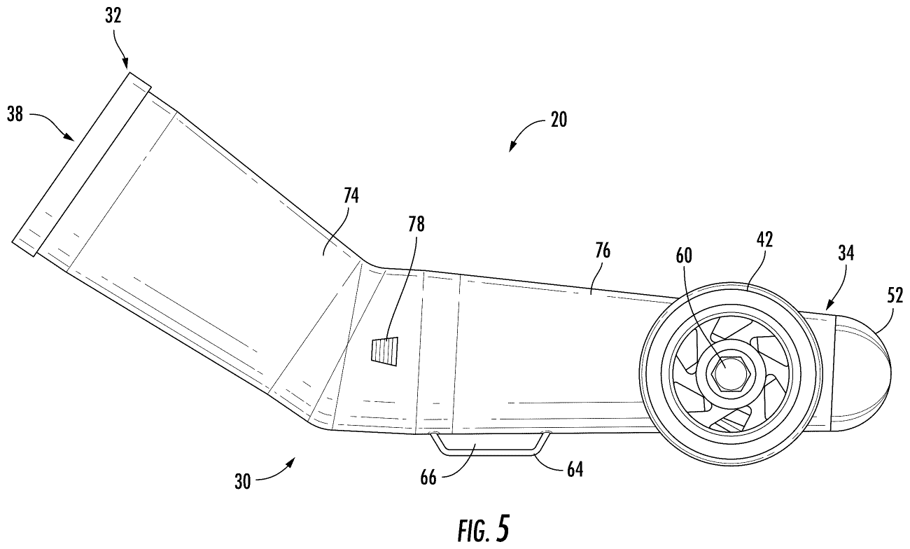

In an example, the housing 30 includes an elbow section 74 that connects to the air blower 40 and tapered section 76 at the second end 34 carrying the ground engaging wheels 42 and having the air discharge 46 formed therein. This elbow section 74 is configured to connect to the portable, handheld air blower 40. FIG. 3 shows two examples of the elbow section 74. The upper example of the elbow section 74 has a longer section that is about 2 inches to about 2 ½ inches longer than the other elbow section below it, and both include a smooth taper as shown in FIGS. 4 and 5. Other views show the elbow section 74 partially cutaway.

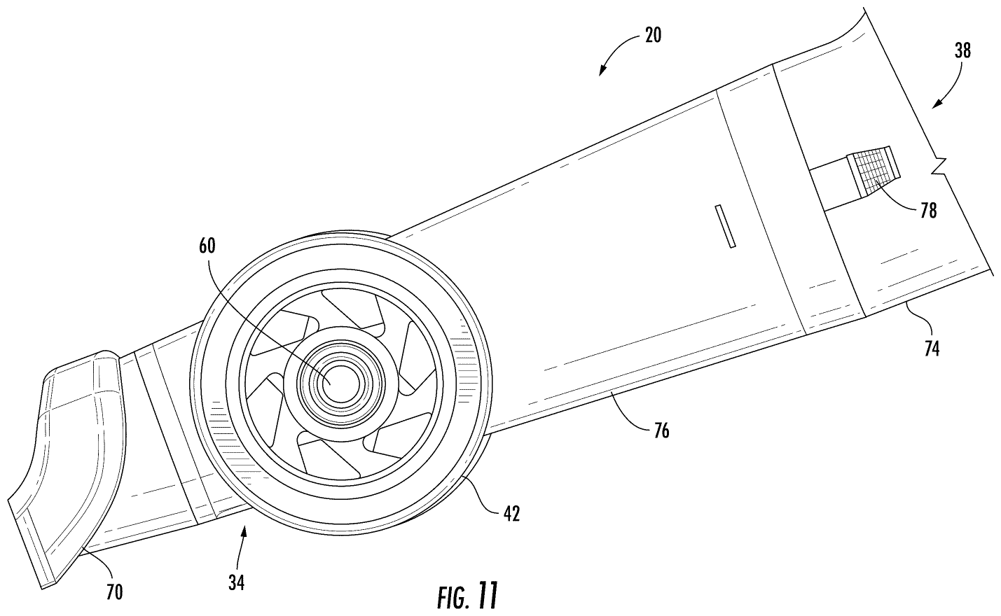

FIG. 9 shows an example of the tapered section 76 carrying the nozzle attachment 70 without showing the ground engaging wheels 42. An end of the tapered section 76 includes clips 78 that permit the tapered section 76 to clip and be removably secured onto the elbow section 74. The clips 78 may be formed as tabs as illustrated in FIGS. 9 and 11.

The dimensions of the housing 30, ground engaging wheels 42, and air discharge 46 may vary, but in an example, the overall length of the apparatus 20 may be about 17 ½ inches, and in an example, from the center of the wheel 64 diameter to an end, about 14 inches to about 14 ½ inches. The first end 32 that connects to the portable, handheld air blower 40 may have about 3 ⅝ inches inside diameter to fit most commercially available portable, handheld air blowers. The housing 30 and its tapered section 70 and elbow section 74 may be formed from a plastic material such as polyurethane, polyvinylchloride (PVC), high density polyethylene, and other lightweight plastic or metallic materials.

An example air blower 40 that may be used with the apparatus 20 is a Stihl BGA 57 battery powered air blower that has up to 123 mph of maximum air velocity and operates silently with reduced noise as compared to other commercially available air blowers. It weighs just over 5 pounds and is compact and portable with a slim design as shown in FIG. 2. It is known to have a run time of up to 25 minutes on a single charge, and using a larger battery with increased capacity, may be used for extended time periods to clean surfaces and lines on the entire game playing surface, such as a clay tennis court.

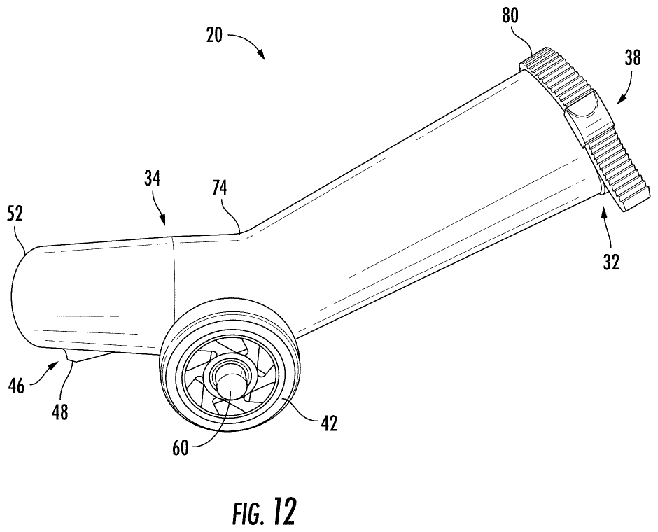

In the example of FIG. 12, the second end 34 of the housing 30 may include a nose cap 52 that has the air discharge 46 formed therein. This nose cap 52 is extended back and longer than previously shown examples, taking the place of the tapered section 76. The first end 32 of the housing may include a bolt strap 80 that helps secure the first end onto the air blower 40.

FIG. 13 is a perspective view of the apparatus 20 looking from the bottom and showing the extended nose cap 52 that supports the opposing dual wheels 64 instead of the elbow section 74, which in this example includes the air discharge 46 formed within the lower elbow section. The dimensions may vary, but in an example from the center point of the wheels 42 to the end of the elbow section 74 may be almost 11 ½ inches and the width from outside of the opposing wheels about 6 inches. The housing may 20 be about 4 inches diameter and the nose cap 52 and portion of the elbow section 74 connected thereto about 5 inches. The end of the nose cap 52 may be about 3 inches diameter. The straight portion of the elbow section 74 may be about 7 inches. From the end of the air discharge 46 to the end of the elbow section 74 that connects to the air blower 40 about 10 inches.

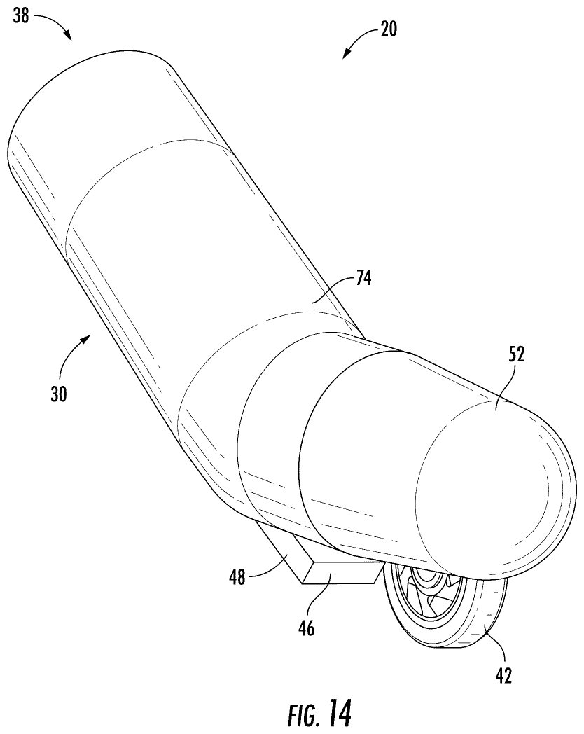

As noted before with reference to FIG. 14, the housing 20 may support a single ground engaging wheel 42, which in this example is mounted in the center underside portion of the extended nose cap 52. The housing 20 may be about 3 inches diameter and straight portion of the elbow section 74 about 6 inches and nose cap 52 and portion of the elbow section 74 connected thereto about 5 ½ inches. From the end of the air discharge 46 to the end of the elbow section 74 that connects to the air blower 40 about 10 inches.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An apparatus for cleaning surfaces and lines on a game playing surface, comprising:
a housing having first and second ends, and an air passage extending from the first end to the second end, the first end configured to connect to a portable, handheld air blower;
at least one ground engaging wheel carried by the housing, said ground engaging wheel configured to allow the housing to be rolled over the game playing surface; and
an air discharge formed at the second end of the housing, said air discharge configured to blow air over the width of a line on the game playing surface as the housing is rolled over the line of the game playing surface when the housing is connected to and receives air discharged from an air blower connected thereto.

2. The apparatus of claim 1 wherein the air discharge is configured as a rectangular protrusion extending outward from a lower section of the housing, said protrusion having a width about equal to the width of lines on the game playing surface.

3. The apparatus of claim 1 wherein the second end of the housing forms a tubular opening, and a nose cap secured onto the second end to prevent air from passing out of the tubular opening.

4. The apparatus of claim 3 wherein the tubular opening is configured to receive a nozzle attachment when the nose cap is removed from the second end of the housing.

5. The apparatus of claim 4 wherein said second end of the housing includes a locking post, said nose cap and nozzle attachment each comprising an L-shaped slot configured to pass over the locking post to lock the respective nose cap or nozzle attachment onto the second end of the housing.

6. The apparatus of claim 1 wherein opposing ground engaging wheels are carried by the second end of the housing.

7. The apparatus of claim 1 wherein a single ground engaging wheel is carried by the second end of the housing.

8. An apparatus for cleaning surfaces and lines on a game playing surface, comprising:
a housing having first and second ends, and an air passage extending from the first end to the second end, the first end configured to connect to a portable, handheld air blower, said housing including an elbow section that connects to the air blower, and a tapered section;
at least one ground engaging wheel carried by the tapered section of the housing, said ground engaging wheel configured to allow the housing to be rolled over the game playing surface; and
an air discharge formed at the second end of the housing, said air discharge configured to blow air over the width of a line on the game playing surface as the housing is rolled over the line of the game playing surface when the housing is connected to and receives air discharged from an air blower connected thereto.

9. The apparatus of claim 8 wherein the air discharge is configured as a rectangular protrusion extending outward from a lower section of the housing, said protrusion having a width about equal to the width of lines on the game playing surface.

10. The apparatus of claim 8 wherein the second end of the housing forms a tubular opening, and a nose cap secured onto the second end to prevent air from passing out of the tubular opening.

11. The apparatus of claim 10 wherein the tubular opening is configured to receive a nozzle attachment when the nose cap is removed from the second end of the housing.

12. The apparatus of claim 11 wherein said second end of the housing includes a locking post, said nose cap and nozzle attachment each comprising an L-shaped slot configured to pass over the locking post to lock the respective nose cap or nozzle attachment onto the second end of the housing.

13. The apparatus of claim 8 wherein opposing ground engaging wheels are carried by the second end of the housing.

14. The apparatus of claim 8 wherein a single ground engaging wheel is carried by the second end of the housing.

15. An apparatus for cleaning surfaces and lines on a game playing surface, comprising:
a housing having first and second ends, and an air passage extending from the first end to the second end, the first end configured to connect to a portable, handheld air blower;
at least one ground engaging wheel carried by the housing, said ground engaging wheel configured to allow the housing to be rolled over the game playing surface; and
an air discharge formed at the second end of the housing, said air discharge configured to blow air over the width of a line on the game playing surface as the housing is rolled over the line of the game playing surface when the housing is connected to and receives air discharged from an air blower connected thereto, and
wherein the second end of the housing comprises a nose cap, said air discharge formed within said nose cap.

16. The apparatus of claim 15 wherein the air discharge is configured as a rectangular protrusion extending outward from a lower section of the nose cap, said protrusion having a width about equal to the width of lines on the game playing surface.

17. The apparatus of claim 15 wherein the second end of the housing at the nose cap forms a tubular opening onto which the nose cap is positioned.

18. The apparatus of claim 17 wherein the tubular opening is configured to receive a nozzle attachment when the nose cap is removed from the second end of the housing.

19. The apparatus of claim 15 wherein opposing ground engaging wheels are carried by the second end of the housing.

20. The apparatus of claim 15 wherein a single ground engaging wheel is carried by the second end of the housing.
